(19) United States
(12) Patent Application Publication
(10) Pub. No.: US 2015/0098889 A1
(43) Pub. Date: Apr. 9, 2015

(54) CARBON DIOXIDE ABSORBING COMPOSITION INCLUDING TERTIARY ALKANOLAMINE, AND METHOD AND APPARATUS FOR ABSORBING CARBON DIOXIDE USING THE SAME

(71) Applicant: KOREA INSTITUTE OF ENERGY RESEARCH, Daejeon (KR)

(72) Inventors: Taesung JUNG, Daejeon (KR); Jong-Nam KIM, Daejeon (KR); Hee Tae BEUM, Daejeon (KR); Sang-Sup HAN, Daejeon (KR); Cheol-Ho MOON, Daejeon (KR); Chang-Sin JO, Gyeonggi-do (KR)

(21) Appl. No.: 14/505,640

(22) Filed: Oct. 3, 2014

(30) Foreign Application Priority Data
Oct. 7, 2013 (KR) 10-2013-0119305

(51) Int. Cl. B01D 53/14; C01B 31/20

(52) U.S. Cl. CPC B01D 53/1493; B01D 53/1425; C01B 31/20
USPC 423/438; 422/187; 252/190

(57) ABSTRACT

This invention relates to a carbon dioxide absorbing composition including a tertiary alkanolamine, and to a method and apparatus for absorbing carbon dioxide using the same, wherein in a process and apparatus for absorbing and recovering carbon dioxide from a gas mixture including carbon dioxide, a solid-phase bicarbonate crystal including high-concentration carbon dioxide is crystallized from a carbon dioxide absorbing composition having absorbed carbon dioxide and is then selectively separated, thereby efficiently recovering and regenerating carbon dioxide.

### BACKGROUND OF THE INVENTION

1. Field of the Invention

The present invention relates to a carbon dioxide absorbing composition including a tertiary alkanolamine, and to a method and apparatus for absorbing carbon dioxide using the same. More particularly, the present invention relates to a carbon dioxide absorbing composition including a tertiary alkanolamine and to a method and apparatus for absorbing carbon dioxide using the same, wherein in a process and apparatus for absorbing and recovering carbon dioxide from a gas mixture including carbon dioxide, a solid-phase bicarbonate crystal including high-concentration carbon dioxide may be crystallized from a carbon dioxide absorbing composition having absorbed carbon dioxide and may then be selectively separated, thereby efficiently recovering and regenerating carbon dioxide.

2. Description of the Related Art

Typically useful as a method of removing and recovering carbon dioxide from a gas mixture such as a flue gas using a carbon dioxide absorbing solution is a process of bringing the absorbing solution into direct contact with the gas mixture so that the absorbent of the absorbing solution is coupled with carbon dioxide to thus remove carbon dioxide, from which a purified gas (carbon dioxide) is obtained. In this process, when energy is supplied to the absorbing solution subjected to an absorbing process, carbon dioxide is separated and recovered from the absorbing solution, and the absorbing solution is regenerated so as to absorb carbon dioxide again.

The absorbing solution for use in such a carbon dioxide absorbing process is exemplified by an amine- or alkali metal-based absorbing solution. The carbon dioxide absorbing process using an alkali metal-based absorbing solution is advantageous in terms of the price of the absorbent and thermochemical safety, compared to an absorbing process using an amine. In particular, because this absorbing solution is stable at high temperature and high pressure, it enables high-purity carbon dioxide to be regenerated at high pressure upon separating the absorbed carbon dioxide from the absorbing solution in a stripper. As such, the carbon dioxide thus produced should be transferred under the condition that it is compressed to a pressure of 50 bar or more to reduce its volume. However, the higher the number of stages of the compressor, the greater the energy consumption used in the process.

Therefore, when an alkali metal-based absorbing solution able to produce carbon dioxide at a high pressure of 1˜20 bar is used, the unit cost and the operation cost for the compressor for compressing carbon dioxide may be considerably reduced. However, upon regeneration at high temperature, the temperature of the reboiler is increased compared to atmospheric pressure, and a large amount of absorbing solution has to be regenerated, undesirably increasing the consumption of energy such as sensible heat, latent heat of vaporization and reaction heat necessary for regeneration.

Generally, when the amount of the absorbing solution to be regenerated in a regenerator is decreased, energy necessary for regeneration may be reduced. Reducing the amount of an absorbing solution transferred to a regenerator includes an alkali metal bicarbonate crystallization method (International Publication No. WO/2011/130796 A1, and U.S. application Ser. No. 12/448,252). However, this method is problematic because a large amount of absorbing solution including carbon dioxide discharged from the absorber should be cooled to a very low temperature, thus increasing the unit cost and the operation cost attributed to the cooling energy and the cooling rate. Furthermore, the absorbing solution at 10˜30° C. discharged from the crystallizer is transferred to an absorber operating at 60˜80° C. and the slurry at low temperature is transferred to a regenerator operating at 100˜250° C., undesirably increasing sensible heat energy due to the temperature difference.

Also when an alkali metal inorganic salt is used as a carbon dioxide absorbing solution, addition of an absorption rate promoter is reported to solve problems with an alkali metal having quite low absorption rate compared to an amine. Examples thereof include primary or secondary amines such as piperazine, 2-methyl piperazine, monoethanolamine (MEA), and diethanolamine (DEA). For the primary or secondary amines, however, the intramolecular amine group may react with carbon dioxide to give a carbamate, in which a process of thermally decomposing a carbamate so as to regenerate it to an amine should be carried out to continuously maintain the effect of the amine additive. This process may cause problems of additional thermal energy supply to heat the amine to high temperature and of long-term stability of the amine due to heating.

### SUMMARY OF THE INVENTION

Accordingly, the present invention has been made keeping in mind the problems encountered in the related art, and an object of the present invention is to provide a carbon dioxide absorbing composition including a tertiary alkanolamine, and a method and apparatus for absorbing carbon dioxide using the same, wherein in a process and apparatus for absorbing and recovering carbon dioxide from a gas mixture including carbon dioxide such as flue gas of coal-fired power plants, a solid-phase bicarbonate crystal including high-concentration carbon dioxide may be crystallized from a carbon dioxide absorbing composition having absorbed carbon dioxide and then may be selectively separated, thereby increasing carbon dioxide recovery efficiency and reducing the energy cost for regeneration.

The present invention provides a method of absorbing and regenerating carbon dioxide, comprising: (a) bringing a carbon dioxide absorbing composition including a tertiary alkanolamine and a carbon dioxide absorbing inorganic salt solution into contact with a gas mixture including carbon dioxide, thus absorbing carbon dioxide; (b) cooling the carbon dioxide absorbing composition having absorbed carbon dioxide so as to be crystallized, thus forming a slurry solution; (c) separating the slurry solution into a solid-phase bicarbonate crystal and a liquid-phase absorbing solution including the tertiary alkanolamine; and (d) recovering the separated liquid-phase absorbing solution including the tertiary alkanolamine and heating the solid-phase bicarbonate crystal to separate carbon dioxide.

In this method, (a) may be performed by spraying the carbon dioxide absorbing composition to the gas mixture including carbon dioxide under conditions of atmospheric pressure and at 60˜80° C. to remove carbon dioxide from a flue gas mixture.

As used herein, the term “carbon dioxide absorbing inorganic salt solution” refers to an aqueous solution of a monovalent inorganic salt including sodium, potassium, lithium, rubidium or cesium capable of absorbing carbon dioxide.

In the carbon dioxide absorbing composition according to the present invention, the carbon dioxide absorbing inorganic salt solution may be a solution obtained by dissolving a monovalent inorganic salt including one or more selected from the group consisting of sodium, potassium, lithium, rubidium and cesium.

The inorganic salt concentration of the carbon dioxide absorbing inorganic salt solution may be 30 wt % or less but exceeding zero when using an inorganic salt including sodium, 50 wt % or less but exceeding zero when using an inorganic salt including potassium, 2 wt % or less but exceeding zero when using an inorganic salt including lithium, 30 wt % or less but exceeding zero when using an inorganic salt including rubidium, or 70 wt % or less but exceeding zero when using an inorganic salt including cesium.

Preferably, the inorganic salt concentration of the carbon dioxide absorbing inorganic salt solution is 15˜30 wt % when using an inorganic slat including sodium or 25˜50 wt % when using an inorganic slat including potassium. If the concentration of the inorganic salt is too low, the degree of supersaturation may decrease and thus the crystal does not precipitate or the production yield may be low. The higher the inorganic salt concentration, the greater the amount of absorbed carbon dioxide. However, if the inorganic salt concentration is excessively high, supersaturation of the carbonate is caused in the solution that is transferred to the absorber, whereby a solid material is created in the absorber and may thus negatively affect gas-liquid material transfer. Furthermore, if the inorganic salt concentration exceeds the above upper limit, the amount of the solvent (water) contained in the absorbing solution is deficient, and thus gas-liquid material transfer may become inefficient and it is difficult to remove the heat of absorption.

The carbon dioxide absorbing composition according to the present invention includes a tertiary alkanolamine. The tertiary alkanolamine may function to enhance the carbon dioxide absorption rate and also to increase the solid-phase bicarbonate crystal production yield, and thus there is no need to remarkably lower the cooling temperature in the course of crystallization. Therefore, the tertiary alkanolamine enables high-purity carbon dioxide to be efficiently absorbed and recovered.

Currently available as the carbon dioxide absorption rate rate promoter is an amine including primary or secondary amine such as monoethanolamine or piperazine based on the fast reaction for forming a carbamate. However, in the continuous processes of collection and recovery of carbon dioxide, the amine having absorbed carbon dioxide is not discarded but has to be reused after removal of carbon dioxide. Because the amine may be produced into a carbamate through the reaction with carbon dioxide, the produced carbamate should be recovered as an amine through thermal decomposition. Such a carbamate has a drawback of very high thermal decomposition heat. On the other hand, the tertiary amine is configured such that a hydrogen atom is not adjacent to a nitrogen atom, and thus no carbamate is formed. Accordingly, since the tertiary amine obviates an amine recovery process through thermal decomposition after absorption of carbon dioxide, additional energy consumption for regeneration is low, thereby achieving energy saving in the course of absorbing and recovering carbon dioxide.

Especially, when the tertiary amine includes a hydroxyl group, the solid-phase bicarbonate crystal production yield, as well as the absorption rate, may be increased. As such, the amine has to be in a liquid phase at room temperature and also to contain at least one hydroxyl group, in order to be efficiently miscible with the carbon dioxide absorbing solution and to prevent the amine from precipitating into a solid.

When the tertiary amine is an aqueous alkanolamine having a hydroxyl group, the solid-liquid phase equilibrium of an inorganic salt is changed, thus increasing the solid-phase bicarbonate crystal production yield.

Useful in the present invention, the tertiary alkanolamine may be represented by the following Structural Formula 1.

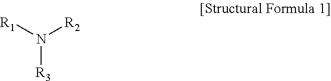

In this formula, Rₙ (n=1 to 3) is an alkyl, at least one of R₁ to R₃ contains one or more hydroxyl (—OH) groups, and all amines in the molecule are a tertiary amine.

In the present invention, the tertiary alkanolamine is a tertiary amine having a hydroxyl group, and may be selected from the group consisting of N-methyldiethanolamine (MDEA), dimethylethanolamine (DMEA), N,N-diethylethanolamine (DESA), triethanolamine (TEA) and mixtures thereof. Particularly useful is MDEA. The use of MDEA may become favorable in terms of the solid-phase bicarbonate crystal production yield.

The tertiary alkanolamine may be contained in an amount 20 wt % or less but exceeding zero, and preferably in an amount of 5˜10 wt %, based on the total weight of the carbon dioxide absorbing composition. Because the amine increases the supersaturation of the bicarbonate slurry, it is preferably added in a large amount. However, if the amine is added in an amount exceeding the upper limit, it may undesirably precipitate into a crystal in the transport pipe to the absorber and the absorber at high temperature before the crystallizer.

The carbon dioxide absorbing composition may further include an alcohol antisolvent to increase the crystallization yield, as necessary.

The alcohol antisolvent may include one or more selected from the group consisting of methanol, ethanol, propanol, ethyleneglycol, propyleneglycol, diethyleneglycol, triethyleneglycol, polyethyleneglycol, N-methylpyrrolidone, propylenecarbonate and ethylenecarbonate.

The carbon dioxide absorbing composition may further include any one or a mixture of two or more selected from the group consisting of an absorption rate promoter, an antioxidant and a corrosion inhibitor.

According to the present invention, the antioxidant and the corrosion inhibitor contained in the carbon dioxide absorbing composition may include, but are not necessarily limited to, vanadium oxide, antimony oxide, potassium dichromate, nickel, iron, copper, chromium ions, 2-aminothiophenol, 1-hydroxyethylidene-1,1-diphosphonic acid and mixtures thereof.

In the method of absorbing carbon dioxide as above, (b) may be performed by cooling the carbon dioxide absorbing composition having absorbed carbon dioxide to 10˜50° C., thus forming a solid-phase bicarbonate crystal. As the cooling temperature is lower, the bicarbonate crystal production yield may increase, but the energy cost for cooling the solution so as to carry out crystallization and for re-heating the solution transferred to the regenerator may be remarkably increased. Hence, the cooling temperature is appropriately set in the above range. The solid-phase bicarbonate crystal includes a large amount of carbon dioxide, thus enabling selective separation and regeneration of a large amount of carbon dioxide through solid-liquid crystallization separation in (c).

In (d), the solid-phase bicarbonate crystal separated from the slurry after (b) may be heated under conditions of 1˜20 bar and 100˜250° C., thus separating carbon dioxide. The bicarbonate crystal may be thermally decomposed into carbonate, water and carbon dioxide even at low temperature at 1 bar corresponding to atmospheric pressure but is thermally decomposed at a high temperature of 150˜250° C. under the condition of a high pressure of 5˜20 bar. Meanwhile, when the bicarbonate is regenerated at high pressure, high-pressure carbon dioxide may be recovered, and thereby a compression process necessary to transport carbon dioxide to an underground or marine storage location may be favorably omitted.

In (d), separating carbon dioxide from the slurry including the solid-phase bicarbonate crystal may be performed by separating the slurry including the solid-phase bicarbonate crystal into carbon dioxide, water and a carbon dioxide absorbing inorganic salt composition.

In addition, the present invention provides an apparatus for absorbing and regenerating carbon dioxide using the aforementioned method, comprising: an absorber for absorbing carbon dioxide from a flue gas using a carbon dioxide absorbing composition; a crystallizer for cooling the carbon dioxide absorbing composition having absorbed carbon dioxide discharged from the absorber using a cooler or a heat exchanger to form a solid-phase bicarbonate crystal; a filter for separating the solid-phase bicarbonate crystal and a liquid-phase absorbing solution including a tertiary alkanolamine from a slurry produced by the crystallizer; and a regenerator for heating the solid-phase bicarbonate crystal to separate carbon dioxide.

The absorber may selectively absorb carbon dioxide.

The regenerator may include a reboiler for decomposing the solid-phase bicarbonate crystal and a condenser for separating water and carbon dioxide from each other.

In addition, the present invention provides a carbon dioxide absorbing composition for use in a process including crystallizing a composition having absorbed carbon dioxide into a solid-phase bicarbonate crystal including high-concentration carbon dioxide and separating and regenerating the crystal, the carbon dioxide absorbing composition comprising: a carbon dioxide absorbing inorganic salt solution and a tertiary alkanolamine. The process including crystallizing the composition having absorbed carbon dioxide into the solid-phase bicarbonate crystal and separating and regenerating the crystal may be a process for selectively separating the bicarbonate crystal and regenerating it at high pressure.

The carbon dioxide absorbing inorganic salt solution may be a solution of a monovalent inorganic salt including one or more selected from the group consisting of sodium, potassium, lithium, rubidium and cesium.

The inorganic salt concentration of the carbon dioxide absorbing inorganic salt solution is 30 wt % or less but exceeding zero when using an inorganic salt including sodium, 50 wt % or less but exceeding zero when using an inorganic salt including potassium, 2 wt % or less but exceeding zero when using an inorganic salt including lithium, 30 wt % or less but exceeding zero when using an inorganic salt including rubidium, or 70 wt % or less but exceeding zero when using an inorganic salt including cesium.

Preferably, the inorganic salt concentration of the carbon dioxide absorbing inorganic salt solution is 15˜30 wt % when using an inorganic salt including sodium or 25˜50 wt % when using an inorganic salt including potassium.

Useful in the present invention, the tertiary alkanolamine is a tertiary amine having a hydroxyl group, and may be selected from the group consisting of N-methyldiethanolamine (MDEA), dimethylethanolamine (DEEA), N,N-diethylethanolamine (DEEA), triethanolamine (TEA) and mixtures thereof. Particularly useful is MDEA. The use of MDEA may become favorable in the solid-phase bicarbonate crystal production yield.

The tertiary alkanolamine is preferably contained in an amount of 20 wt % or less but exceeding zero, and more preferably 5˜10 wt %, based on the total weight of the carbon dioxide absorbing composition.

A detailed description of the carbon dioxide absorbing inorganic salt aqueous solution and the tertiary alkanolamine is the same as that of the method of absorbing and regenerating carbon dioxide as above and is thus omitted.

The carbon dioxide absorbing composition may further an alcohol antisolvent to increase the crystallization yield, as necessary. The alcohol antisolvent may include one or more selected from the group consisting of methanol, ethanol, propanol, ethyleneglycol, propyleneglycol, diethyleneglycol, triethyleneglycol, polyethyleneglycol, N-methylpyrrolidone, propylenecarbonate and ethylenecarbonate.

The carbon dioxide absorbing composition may further include any one or a mixture of two or more selected from the group consisting of an absorption rate promoter, an antioxidant and a corrosion inhibitor. The antioxidant and the corrosion inhibitor in the carbon dioxide absorbing composition according to the present invention may include, but are not necessarily limited to, vanadium oxide, antimony oxide, potassium dichromate, nickel, iron, copper, chromium ions, 2-aminothiophenol, 1-hydroxyethylidene-1,1-diphosphonic acid and mixtures thereof.

According to the present invention, when a carbon dioxide absorbing composition obtained by mixing a carbon dioxide absorbing inorganic salt solution containing an alkali metal with a tertiary alkanolamine is used, the carbon dioxide absorption rate can be increased, and a high solid-phase bicarbonate crystal yield can result. Thus, only the solid-phase bicarbonate crystal is separated and utilized in a process for recovering and regenerating carbon dioxide, thereby increasing carbon dioxide recovery efficiency and decreasing the energy cost necessary for regeneration. Specifically, as the amount of water transferred to the regenerator is reduced, the amount of a carbon dioxide absorbent to be regenerated can be remarkably lowered, ultimately decreasing the generation of sensible heat and latent heat required for cooling and heating.

### BRIEF DESCRIPTION OF THE DRAWINGS

The above and other objects, features and advantages of the present invention will be more clearly understood from the following detailed description taken in conjunction with the accompanying drawings, in which:

FIG. 1 schematically illustrates an apparatus for absorbing and recovering carbon dioxide according to the present invention;

FIG. 2 illustrates the results of analysis of the carbon dioxide absorption rate of carbon dioxide absorbing compositions;

FIG. 3 illustrates the results of bicarbonate crystal production yield of carbon dioxide absorbing compositions;

FIG. 4 illustrates the IR spectroscopic results of bicarbonate crystals;

FIG. 5 illustrates the results of thermogravimetric analysis (TGA) of bicarbonate crystals; and

FIG. 6 illustrates the results of ¹³C-NMR analysis of liquid-phase absorbing solutions including amine, as separated by a filter.

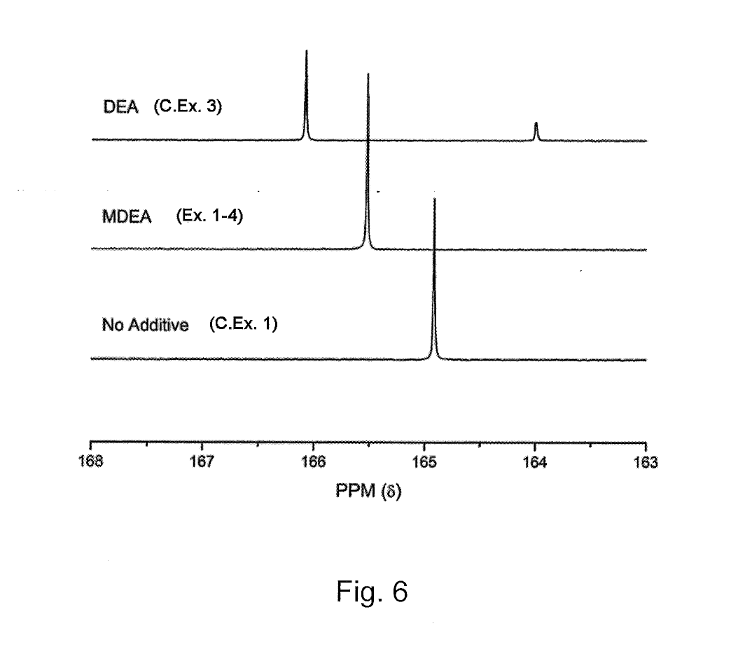

### DESCRIPTION OF SPECIFIC EMBODIMENTS

Hereinafter, a detailed description will be given of the present invention. The present invention is not limited to the following embodiments, and may be modified into other forms. Such embodiments disclosed herein are provided so that the spirit of the present invention is sufficiently conveyed to those skilled in the art, and are not be construed as limiting the present invention.

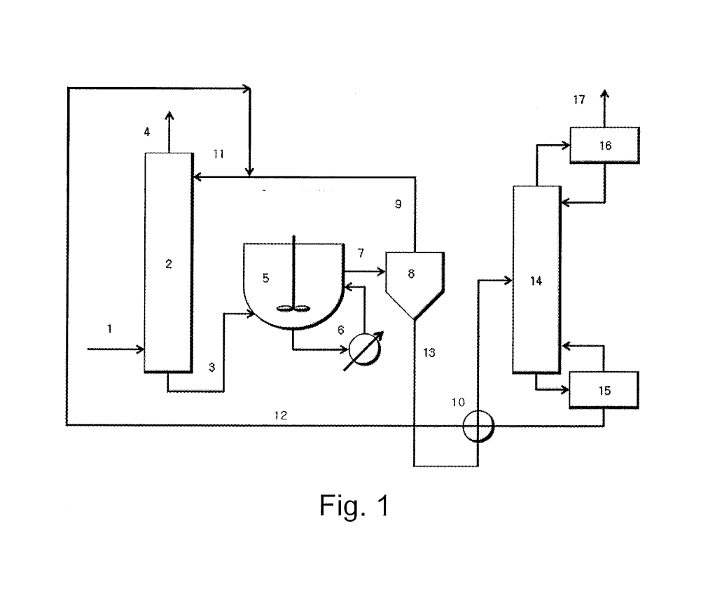

Below is a description of a method and apparatus for recovering and regenerating carbon dioxide by crystallizing and separating a bicarbonate slurry using a tertiary alkanolamine contained in a carbon dioxide absorbing composition according to the present invention, with reference to FIG. 1.

As illustrated in FIG. 1, the apparatus for absorbing and regenerating carbon dioxide according to the present invention includes an absorber 2 for absorbing carbon dioxide from a flue gas 1 using a carbon dioxide absorbing composition 11 according to the present invention; a crystallizer 5 for cooling a carbon dioxide absorbing composition 3 having absorbed carbon dioxide using a cooler or a heat exchanger 6 to form a solid-phase bicarbonate crystal; a filter 8 for separating the solid-phase bicarbonate crystal 13 and a liquid-phase solution including a tertiary alkanolamine from a slurry 7 produced by the crystallizer 5; and a regenerator 14 for heating the solid-phase bicarbonate crystal 13 to separate carbon dioxide. The absorber 2 may function to selectively absorb carbon dioxide from the flue gas 1.

The regenerator 14 may include a reboiler 15 and a condenser 16, and the reboiler 15 may be provided under the regenerator 14 and the condenser 16 may be provided above the regenerator 14.

In the absorber 2, the carbon dioxide absorbing composition 11 is brought into contact with the gas mixture including carbon dioxide, for example, the flue gas 1 to thus absorb carbon dioxide.

When the flue gas 1 is fed into the absorber 2, the carbon dioxide absorbing composition 11 is sprayed from the top of the absorber using a nozzle under conditions of atmospheric pressure and 60˜80° C. When the sprayed carbon dioxide absorbing composition 11 absorbs the fed carbon dioxide, the carbon dioxide absorbing composition 3 having absorbed carbon dioxide is discharged from the bottom of the absorber 2. To increase the material transfer due to gas-liquid contact, a packing material may be provided in the absorber 2. Also to increase the material transfer due to gas-liquid contact, the carbon dioxide absorbing composition 11 may be sprayed using a spray nozzle, but no limitation is imposed on the spraying process.

Subsequently, the carbon dioxide absorbing composition 3 having absorbed carbon dioxide, which was transferred to the crystallizer 5 from the absorber 2, is cooled, so that a solid-phase bicarbonate crystal is produced.

This cooling process is performed using a cooler or a heat exchanger 6, and the carbon dioxide absorbing composition 3 having absorbed carbon dioxide is cooled to 10˜50° C. to thus cause supersaturation of a bicarbonate slurry. The cooler or the heat exchanger 6 may be located inside or outside the crystallizer 5, and a stirrer may be further provided to increase heat transfer efficiency of the carbon dioxide absorbing composition 3. Useful is a crystallizer that is able to increase the size of slurry particles by separating small particles and removing them through heating or in which there is flow therein, but the kind of crystallizer is not limited.

As such, since the tertiary alkanolamine contained in the carbon dioxide absorbing composition 11 may increase the bicarbonate crystal production yield, there is no need to remarkably lower the cooling temperature. The slurry produced by the crystallizer 5 is separated into the solid-phase bicarbonate crystal 13 containing carbon dioxide in a relatively large amount and the liquid-phase absorbing solution 9 including the tertiary alkanolamine containing carbon dioxide in a small amount, by means of the filter 8. Examples of the filter 8 may include a filter, a cyclone, and a settling tank, each for separating a solid and a liquid from each other.

Next, the solid-phase bicarbonate crystal 13 and the liquid-phase absorbing solution 9 including the tertiary alkanolamine are separated from the slurry, and the liquid-phase solution 9 including the tertiary alkanolamine is then circulated to the absorber 2.

The separated solid-phase bicarbonate crystal 13 is transferred to the regenerator 14, and then separated into carbon dioxide, water and a carbon dioxide absorbing inorganic salt solution under conditions of 1˜20 bar and 100˜250° C. The regenerator 14 includes a reboiler 15 thereunder to supply steam so that the slurry is decomposed, and also includes a condenser 16 thereabove so that water to be evaporated is condensed and then refluxed via the regenerator 14, ultimately recovering high-purity carbon dioxide 17.

The regenerator 14 may be provided in the form of a column including a packing material therein or a stirring pressure reaction tank, but is not necessarily limited thereto. The regenerated absorbing solution 12 recovered from the regenerator 14 includes low-concentration carbon dioxide. It is mixed with the liquid-phase absorbing solution 9 including the tertiary alkanolamine via the heat exchanger 10, and is then circulated to the absorber 2. Specifically, the regenerated absorbing solution 12 having no carbon dioxide is recovered to the absorber 2 from the bottom of the regenerator 14. The carbon dioxide discharged from the top of the regenerator 14 is dewatered using the condenser 16, and water is refluxed to the regenerator 14 and the regenerated high-purity carbon dioxide 17 is recovered as a product.

Meanwhile, heat may be recovered from the low-temperature liquid-phase absorbing solution 9 discharged from the filter 8 and the carbon dioxide absorbing composition 3 having absorbed carbon dioxide discharged from the absorber 2, by use of the heat exchanger, and the heat exchanger may be additionally provided to increase heat exchange efficiency.

### EXAMPLE 1

A carbon dioxide (CO₂) absorbing composition was prepared by mixing a CO₂ absorbing solution having 30 wt % of K₂CO₃ with MDEA as a tertiary alkanolamine.

### EXAMPLE 1-1

A CO₂ absorbing composition was prepared by adding MDEA in an amount of 2.5 wt % based on the total weight of the composition.

### EXAMPLE 1-2

A CO₂ absorbing composition was prepared by adding MDEA in an amount of 5 wt % based on the total weight of the composition.

### EXAMPLE 1-3

A CO₂ absorbing composition was prepared by adding MDEA in an amount of 7.5 wt % based on the total weight of the composition.

### EXAMPLE 1-4

A CO₂ absorbing composition was prepared by adding MDEA in an amount of 10 wt % based on the total weight of the composition.

### COMPARATIVE EXAMPLE 1

A CO₂ absorbing solution having 30 wt % of K₂CO₃ was prepared. No amine was added.

### COMPARATIVE EXAMPLE 2

A CO₂ absorbing composition was prepared by mixing a CO₂ absorbing solution having 30 wt % of K₂CO₃ with piperazine as a secondary amine in an amount of 10 wt % based on the total weight of the composition.

### COMPARATIVE EXAMPLE 3

A CO₂ absorbing composition was prepared by mixing a CO₂ absorbing solution having 30 wt % of K₂CO₃ with diethanolamine as a secondary amine in an amount of 10 wt % based on the total weight of the composition.

### TEST EXAMPLE 1

### Evaluation of CO₂ Absorption Rate

CO₂ Absorption Rate of CO₂ Absorbing Composition with Tertiary Alkanolamine

The CO₂ absorption rate of the CO₂ absorbing composition was measured using a stirring cell absorption unit. The reactor cell was located in a thermostat at 40° C., after which the CO₂ absorbing composition of Example 1-4 was placed and then the reactor cell was depressurized to a vacuum, thus removing the residual gas. The solution in the reactor cell was mixed well using a magnetic stirrer. Then, when the temperature and the pressure of the reactor cell became uniform, CO₂ was instantly injected, and the pressure thereof was adjusted to 5 barA, after which the injection valve was closed, and changes in CO₂ pressure over time were measured.

CO₂ Absorption Rate of CO₂ Absorbing Composition without Amine Additive

The reactor cell was located in a thermostat at 40° C., the CO₂ absorbing solution of Comparative Example 1 was fed, and then the reactor cell was depressurized to a vacuum, thus removing the residual gas. The solution in the reactor cell was mixed well using a magnetic stirrer. Then, when the temperature and the pressure of the reactor cell became uniform, CO₂ was instantly injected, and the pressure thereof was adjusted to 5 barA, after which the injection valve was closed, and changes in CO₂ pressure over time were measured.

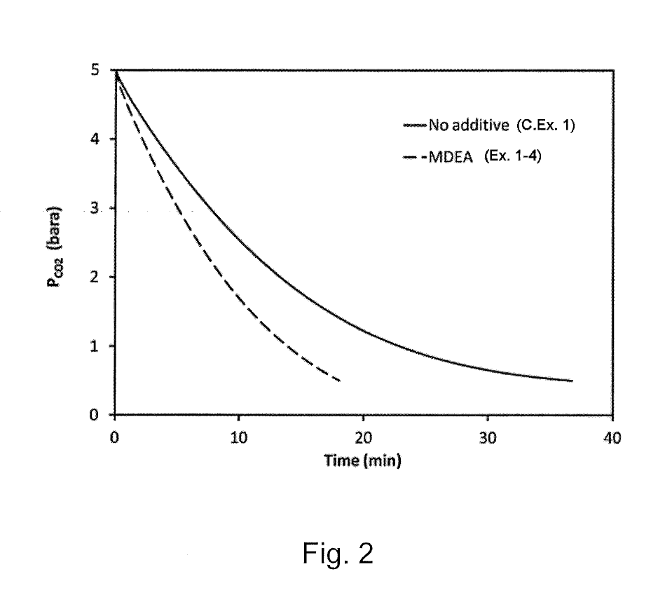

The results of evaluation of CO₂ absorption rate are illustrated in FIG. 2. The CO₂ pressure was obviously decreased in the presence of the amine additive. Thereby, the amine additive was responsible for increasing the CO₂ absorption rate.

The period of time required to reach the CO₂ pressure of 0.5 barA was measured to be 36 min in Comparative Example 1 (including no additive), and 18 min in Example 1-4 (including 10 wt % of MDEA). Ultimately, the CO₂ absorption rate of the inorganic salt solution can be confirmed to be increased by MDEA.

### TEST EXAMPLE 2

### Analysis of Bicarbonate Crystal Production Yield of CO₂ Absorbing Composition

Bicarbonate Crystal Production Yield of CO₂ Absorbing Composition with Tertiary Alkanolamine

350 g (1.7 mole K⁺) of the CO₂ absorbing composition of Example 1 was prepared. 300 mL of the prepared CO₂ absorbing composition was placed in a double-pipe reactor, stirred using a stirrer, added with 1.07 mole CO₂, heated so as to be dissolved at 80° C., and then cooled to 25° C. at a rate of 1° C./min. After completion of the cooling, the crystal was separated using a filter paper having 1 μm sized pores, dried in an oven at 60° C. and then analyzed.

Bicarbonate Crystal Production Yield of CO₂ Absorbing Composition without Amine Additive

The absorbing solution of Comparative Example 1 was prepared, and analyzed as above.

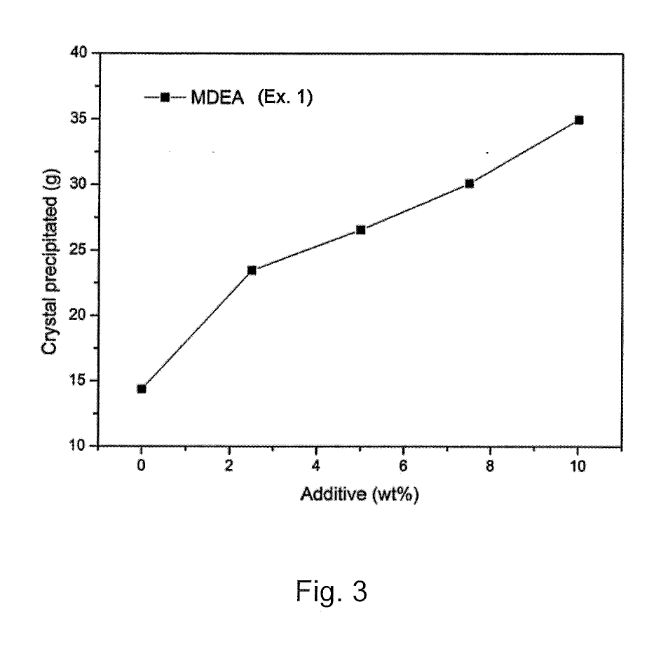

The analytical results are illustrated in FIG. 3. As the amount of added MDEA was higher, the amount of produced crystal was increased.

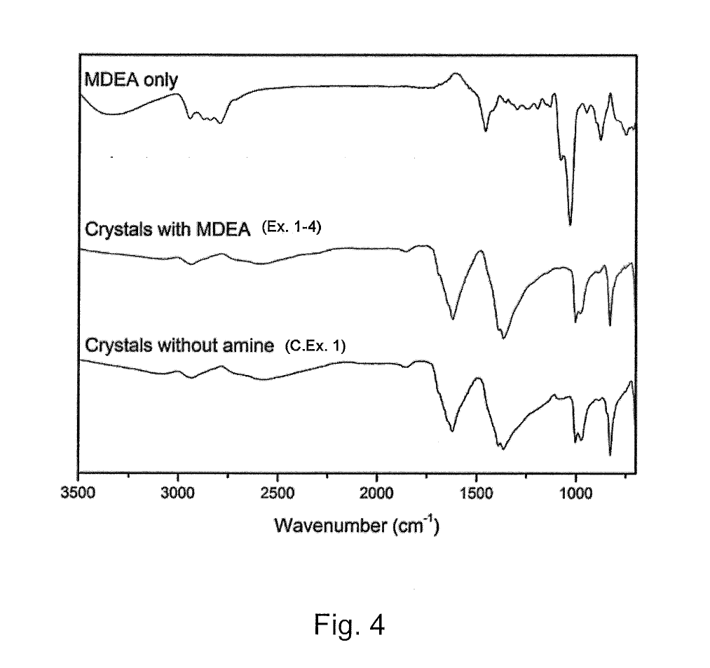

Whether the produced crystal contains the amine as the impurity was analyzed by Fourier-transform infrared (FT-IR) spectroscopy. The results are illustrated in FIG. 4. The FT-IR spectrum of the crystal resulting from crystallizing Example 1-4 (CO₂ absorbing composition including 10 wt % of MDEA) agreed with the results of Comparative Example 1 (absorbing solution including no amine). Furthermore, based on the results of powder X-ray diffraction analysis, any crystal such as carbamate other than KHCO₃ did not precipitate in the produced crystal.

### TEST EXAMPLE 3

### TGA

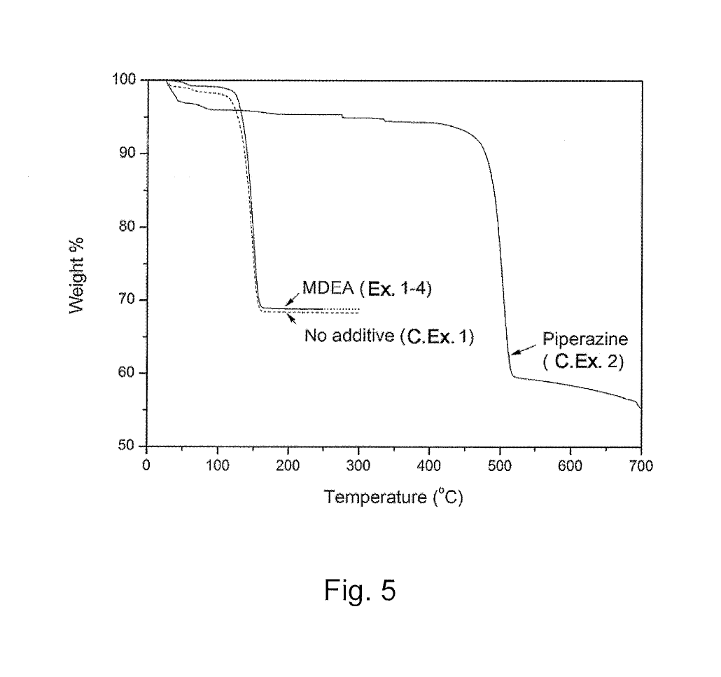

The crystals produced from the CO₂ absorbing solution of Comparative Example 1, from the CO₂ absorbing composition of Example 1-4 and from the composition of Comparative Example 2 were subjected to TGA. The results are illustrated in FIG. 5. The crystallization process was performed in the same manner as in Test Example 2. In Comparative Example 1 (including no additive) and Example 1-4 (including MDEA), all the produced crystals were thermally decomposed at about 150° C. This means that KHCO₃ was decomposed into K₂CO₃, H₂O and CO₂. However, the decomposition temperature of Comparative Example 2 (including piperazine) arrived at 500° C. This means that the produced crystal was not KHCO₃ but was a potassium piperazine carbamate. These results agreed with the results of powder X-ray diffraction analysis. Thus, the secondary amine that gives a carbamate is not preferable as a crystallization additive, and a primary amine causes the same procedure, which is considered to be unfavorable as a crystallization additive.

### TEST EXAMPLE 4

### ¹³C-NMR Spectroscopy

The residual solution obtained by removing the crystal produced from the CO₂ absorbing composition of Example 1-4, and the residual solutions obtained by removing the crystals produced from the absorbing solution of Comparative Example 1 and the composition of Comparative Example 3 were subjected to ¹³C-NMR spectroscopy. The crystallization process was carried out in the same manner as in Test Example 2. In the residual solutions of Comparative Example 1 (including no additive) and Example 1-4 (including MDEA), only the HCO₃⁻/CO₃²⁻ peak was observed, and the peak of the carbamate ion was not observed. However, in the residual solution of Comparative Example 3 (including diethanolamine), the HCO₃⁻/CO₃²⁻ peak and the carbamate ion peak near 164 were observed. Although such a carbamate has to be recovered as an amine through thermal decomposition requiring high reaction heat, the tertiary alkanolamine such as MDEA does not form any carbamate, thus obviating additional thermal decomposition. Hence, the tertiary alkanolamine is considered to be preferable as a crystallization additive, compared to typical primary and secondary amines.

### TEST EXAMPLE 5

### Analysis of Crystallization Yield and Regeneration and Recovery Capabilities of CO₂ Absorbing Composition

The CO₂ absorbing composition having absorbed CO₂ was precipitated into a crystal including high-concentration CO₂ using a crystallization process and the crystal was selectively separated and then regenerated at high temperature. Thereby, the crystallization yield according to the flow diagram shown in FIG. 1 was calculated for the amount of recovered CO₂ and the CO₂ content of the regenerated absorbing solution, and thus the effects of the amine additive were compared. The CO₂ absorbing solution of Comparative Example 1 and the CO₂ absorbing composition of Example 1-4 were prepared, and 350 g of a CO₂ absorbing composition 3 having absorbed CO₂ corresponding to CO₂ loading (α=mole-CO₂/mole-K⁺) of 1.126 was prepared in the absorber 2. The specific components are shown in Table 1 below. The CO₂ absorbing composition having absorbed CO₂ was transferred to the cooling crystallizer 5 from the absorber 2, and then cooled to 25° C. from 80° C. with stirring. After completion of the cooling, only the precipitated solid-phase crystal 13 was recovered using a metering pump. The recovered crystal was composed of 95% KHCO₃ and 5% water, and contained the amine additive in a very small amount. Although 350 g of the absorbing solution should be thoroughly recovered in a conventional absorbing process, the absorption-regeneration process including the separation process based on the crystallization according to the present invention is applied to only the solid-phase crystal 13. The weight of the solid-phase crystal 13 employed in the regeneration process is 1/10 or less compared to conventional techniques, and thus the regeneration energy and the sensible heat and evaporation heat necessary for heating may be remarkably decreased. The separated solid-phase crystal was transferred to the regenerator 14, regenerated at 200° C. and 6 bar, and separated into a product CO₂ 17, water and a CO₂ absorbing inorganic salt solution. The water was refluxed to the regenerator 14 through the condenser 16 and the regenerated CO₂ absorbing inorganic salt solution 12 was mixed with the liquid-phase absorbing solution 9 including amine separated from the cooling crystallizer 5, so that a CO₂ absorbing composition 11 was prepared again. The results calculated through the crystallization yields for individual compositions in such processes are shown in Table 1 below.

TABLE 1

| | | C. Ex. 1 | Ex. 1-4 |
|---|---|---|---|
| CO₂ absorbing | Total mass (g) | 350 | 350 |
| composition having | Additive mass (g) | 0 | 35 |
| absorbed CO₂ 3 | mol-K⁺ (mol) | 1.707 | 1.707 |
| | mol-CO₂ (mol) | 1.923 | 1.923 |
| | CO₂ loading (—) | 1.126 | 1.126 |
| Solid-phase | Mass (g) | 14.37 | 34.97 |
| crystal 13 | mol-K⁺ (mol) | 0.1435 | 0.3493 |
| | mol-CO₂ (mol) | 0.1435 | 0.3493 |
| | CO₂ loading (—) | 1 | 1 |
| Liquid-phase | Mass (g) | 335.63 | 315.03 |
| absorbing | mol-K⁺ (mol) | 1.564 | 1.358 |
| solution 9 | mol-CO₂ (mol) | 1.779 | 1.573 |
| | CO₂ loading (—) | 1.138 | 1.159 |
| Regenerated | Mass (g) | 11.21 | 27.29 |
| absorbing | mol-K⁺ (mol) | 0.1435 | 0.3493 |
| solution 12 | mol-CO₂ (mol) | 0.0718 | 0.1746 |
| | CO₂ loading (—) | 0.5 | 0.5 |
| CO₂ 17 | mol-CO₂ (mol) | 0.0718 | 0.1746 |
| CO₂ absorbing | Mass (g) | 346.84 | 342.32 |
| composition 11 | mol-K⁺ (mol) | 1.707 | 1.707 |
| | mol-CO₂ (mol) | 1.851 | 1.748 |
| | CO₂ loading (—) | 1.084 | 1.023 |

The solid-phase crystal 13 was produced in a larger amount in the presence of the tertiary alkanolamine than in the absence of the tertiary alkanolamine. The amount of CO₂ 17 calculated through the crystallization yield was proportional to the separated solid-phase crystal yield. Briefly, such a yield was greatly increased in the group including the tertiary alkanolamine. Hence, the addition of the tertiary alkanolamine is considered to be very favorable in terms of recovering CO₂. Furthermore, when using the tertiary alkanolamine, the mixture comprising the regenerated absorbing solution 12 and the separated absorbing solution 9, namely, the CO₂ absorbing composition 11, had CO₂ loading much lower than the initial value. This means that a larger amount of CO₂ may be rapidly absorbed in the absorber.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A method of absorbing and regenerating carbon dioxide, comprising:
(a) bringing a carbon dioxide absorbing composition including a tertiary alkanolamine and a carbon dioxide absorbing inorganic salt solution into contact with a gas mixture including carbon dioxide, thus absorbing carbon dioxide;
(b) cooling the carbon dioxide absorbing composition having absorbed carbon dioxide so as to be crystallized, thus forming a slurry solution;
(c) separating the slurry solution into a solid-phase bicarbonate crystal and a liquid-phase absorbing solution including the tertiary alkanolamine; and
(d) recovering the separated liquid-phase absorbing solution and heating the solid-phase bicarbonate crystal to separate carbon dioxide.

2. The method of claim 1, wherein (a) is performed by spraying the carbon dioxide absorbing composition to the gas mixture including carbon dioxide under conditions of atmospheric pressure and 60˜80° C. to remove carbon dioxide from a flue gas mixture.

3. The method of claim 1, wherein the carbon dioxide absorbing inorganic salt solution is a solution of a monovalent inorganic salt including one or more selected from the group consisting of sodium, potassium, lithium, rubidium and cesium.

4. The method of claim 1, wherein an inorganic salt concentration of the carbon dioxide absorbing inorganic salt solution is 30 wt % or less but exceeding zero when using an inorganic salt including sodium, 50 wt % or less but exceeding zero when using an inorganic salt including potassium, 2 wt % or less but exceeding zero when using an inorganic salt including lithium, 30 wt % or less but exceeding zero when using an inorganic salt including rubidium, or 70 wt % or less but exceeding zero when using an inorganic salt including cesium.

5. The method of claim 1, wherein an inorganic salt concentration of the carbon dioxide absorbing inorganic salt solution is 15˜30 wt % when using an inorganic salt including sodium, or 25˜50 wt % when using an inorganic salt including potassium.

6. The method of claim 1, wherein the tertiary alkanolamine is selected from the group consisting of N-methyldiethanolamine, dimethylethanolamine, N,N-diethylethanolamine, triethanolamine and mixtures thereof.

7. The method of claim 1, wherein the tertiary alkanolamine is contained in an amount of 20 wt % or less but exceeding zero based on a total weight of the carbon dioxide absorbing composition.

8. The method of claim 1, wherein (b) is performed by cooling the carbon dioxide absorbing composition having absorbed carbon dioxide to 10˜50° C. to form the bicarbonate crystal.

9. The method of claim 1, wherein (d) is performed by heating the solid-phase bicarbonate crystal separated from the slurry solution under conditions of 1˜20 bar and 100˜250° C. to separate carbon dioxide.

10. The method of claim 1, wherein separating the carbon dioxide from the solid-phase bicarbonate crystal in (d) is performed by separating the solid-phase bicarbonate crystal into carbon dioxide, water and a carbon dioxide absorbing inorganic salt composition.

11. An apparatus for absorbing and regenerating carbon dioxide using the method of claim 1, comprising:
an absorber for absorbing carbon dioxide from a flue gas using a carbon dioxide absorbing composition;
a crystallizer for cooling the carbon dioxide absorbing composition having absorbed carbon dioxide discharged from the absorber using a cooler or a heat exchanger to form a solid-phase bicarbonate crystal;
a filter for separating the solid-phase bicarbonate crystal and a liquid-phase absorbing solution including a tertiary alkanolamine from a slurry produced by the crystallizer; and
a regenerator for heating the solid-phase bicarbonate crystal to separate carbon dioxide.

12. The apparatus of claim 11, wherein the regenerator comprises a reboiler for decomposing the solid-phase bicarbonate crystal and a condenser for separating water and carbon dioxide from each other.

13. A carbon dioxide absorbing composition for use in a process including crystallizing a composition having absorbed carbon dioxide into a solid-phase bicarbonate crystal having high-concentration carbon dioxide and separating and regenerating the crystal, comprising:
a carbon dioxide absorbing inorganic salt solution and a tertiary alkanolamine.

14. The composition of claim 13, wherein the carbon dioxide absorbing inorganic salt solution is a solution of a monovalent inorganic salt including one or more selected from the group consisting of sodium, potassium, lithium, rubidium and cesium.

15. The composition of claim 13, wherein an inorganic salt concentration of the carbon dioxide absorbing inorganic salt solution is 30 wt % or less but exceeding zero when using an inorganic salt including sodium, 50 wt % or less but exceeding zero when using an inorganic salt including potassium, 2 wt % or less but exceeding zero when using an inorganic salt including lithium, 30 wt % or less but exceeding zero when using an inorganic salt including rubidium, or 70 wt % or less but exceeding zero when using an inorganic salt including cesium.

16. The composition of claim 13, wherein the tertiary alkanolamine is selected from the group consisting of N-methyldiethanolamine, dimethylethanolamine, N,N-diethylethanolamine, triethanolamine and mixtures thereof.

17. The composition of claim 13, wherein the tertiary alkanolamine is contained in an amount of 20 wt % or less but exceeding zero based on a total weight of the carbon dioxide absorbing composition.

18. The composition of claim 13, further comprising an alcohol antisolvent.

19. The composition of claim 18, wherein the alcohol antisolvent includes one or more selected from the group consisting of methanol, ethanol, propanol, ethyleneglycol, propyleneglycol, diethyleneglycol, triethyleneglycol, polyethyleneglycol, N-methylpyrrolidone, propylenecarbonate and ethylenecarbonate.

20. The composition of claim 13, further comprising any one or a mixture of two or more selected from an absorption rate promoter, an antioxidant and a corrosion inhibitor.
